(19) United States
(12) Patent Application Publication
(10) Pub. No.: US 2003/0235031 A1
(43) Pub. Date: Dec. 25, 2003

(54) Multipurpose changeable module

(76) Inventor: Chao-Yuan Lo, Tu Chen City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/268,141

(22) Filed: Oct. 8, 2002

(30) Foreign Application Priority Data
Jun. 19, 2002 (TW) 91113410

(51) Int. Cl. G06F 1/16

(52) U.S. Cl. 361/685

(57) ABSTRACT

A multipurpose changeable module of a notebook computer is described. The multipurpose changeable module has a removable device module and a module case to install the removable device module in the notebook computer. The module case is attached to a motherboard in the notebook computer. There is a predetermined space between the module case and the motherboard to allow mounting of electronic devices on the motherboard. Therefore, the space of the motherboard may be extended. The module case further comprises a switch, a connecting rod, a latch and a push arm to release the removable device module. Hence, the removable device module is easily installed and released from the notebook computer. The removable device module comprises a floppy disk drive, hard disk, CD-ROM drive, CD-RW drive, DVD drive or secondary battery.

### FIELD OF THE INVENTION

The present invention relates to a multipurpose changeable module and especially to a multipurpose changeable module for a notebook computer.

### BACKGROUND OF THE INVENTION

Information technology and the computer industry are highly developed now. People rely heavily on computer systems. The computer operates with a central processing unit (CPU) and other peripheral devices, such as a floppy disk (FD) drive, hard disk (HDD), compact disk read-only memory (CD-ROM) drive, rewritable CD (CD-RW) drive, digital video disk (DVD) drive and so on. All these devices have a driving motor, therefore how to install these devices in a computer without excessive vibration is an important question.

The notebook computer product is popular in the market. The price thereof is acceptable to the user. Further, the key component of the notebook computer is cheaper now. The notebook computer occupation rate is approaching the occupation rate of the desktop computer. Furthermore, the functions and performance of the notebook computer are approaching those of the desktop computer. The occupation rate of the notebook computer should increase due to requirements for office mobility and the electronic-enterprise trend caused by the popular use of the Internet in the world.

Different users of notebook computers need different peripheral devices for their businesses. A natural bottleneck of the notebook computer is that the inside space is too small to install all peripheral devices. Space on the notebook computer motherboard is especially tight. More complex functions mean a more complex motherboard. When space is limited, efficient space utilization enhances the function and performance of the notebook computer.

Hence, a changeable module for a notebook computer has been developed and external peripheral devices are moved inside the notebook computer. The mobility of a notebook computer increases. But the inside space problem is more serious. FIG. 1 is a schematic view of a traditional notebook computer with a changeable module. The notebook computer 10 had a lower casing 14, a motherboard 12 and a changeable module 16. A part of the motherboard 12 is cut so that changeable module 16 can be installed without interference. Therefore, the space on the motherboard 12 is smaller. Accordingly, efficient space utilization in a notebook computer enhances the extension capability, the mobility, the function and the performance thereof.

### SUMMARY OF THE INVENTION

One object of the present invention is to provide a multipurpose changeable module of a notebook computer.

Another object of the present invention is to provide a multipurpose changeable module of a notebook computer to increase the space on the motherboard of the notebook computer.

A further object of the present invention is to provide a multipurpose changeable module of a notebook computer to increase the extension capability and the mobility of the notebook computer.

The present invention provides a multipurpose changeable module of a notebook computer. The multipurpose changeable module comprises a device module with an opening and a module case. The module case is installed inside the notebook computer and positioned above a motherboard of the notebook computer. The module case is installed in a casing of the notebook computer through the motherboard and forms a predetermined space between the module case and the motherboard to avoid contact between the module case and electronic components mounted on the motherboard. The device module is fixed in the module case while the device module is working.

The module case further comprises a switch, a connecting rod, and a latch. The switch releases the device module. The connecting rod connects with the switch to push the latch and withdraw the same from the opening of the device module to release the device module from the module case. The module case further comprises a push arm connected with the connecting rod to push the device module out after the latch withdraws from the opening of the device module. The switch can send an electrical signal to a running application software of the notebook computer before the latch releases the device module to enhance the safety of the releasing device module and the notebook computer.

The device module is a changeable device module, which is a peripheral device such as a floppy disk drive, a hard disk, a compact disk drive, a rewritable compact disk drive, a digital video disk drive, or a battery. The module case further comprises an isolation plate to separate the device module and the electronic components. The isolation plate includes a metal plate and an insulating plate.

Therefore, the present invention can increase the usable space on the motherboard and function and performance of the notebook computer can be enhanced. Further, the extension capability can be increased and the weight can be reduced. In particular, work time can be extended with the secondary battery module.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of a traditional notebook computer with a changeable module;

FIG. 2 is a preferred embodiment according to the present invention;

FIG. 3A is a schematic view of a second hard disk, one changeable device module of FIG. 2;

FIG. 3B is a schematic view of a floppy disk drive, another changeable device module of FIG. 2;

FIG. 4A is a top view of the preferred embodiment of FIG. 2;

FIG. 4B is a front view of the preferred embodiment of FIG. 2 with the section of the motherboard and the lower casing; and

FIG. 5 is an exploded view of the preferred embodiment of FIG. 2.

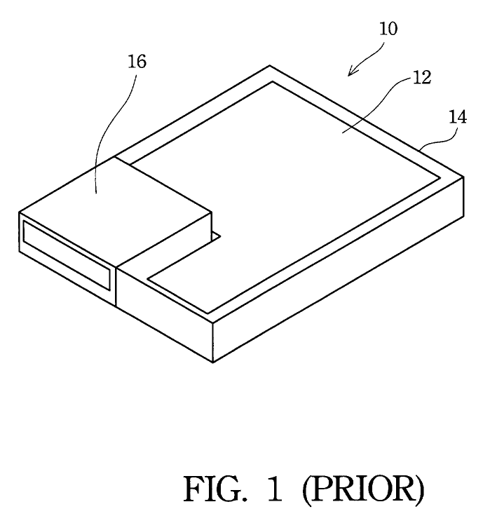

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

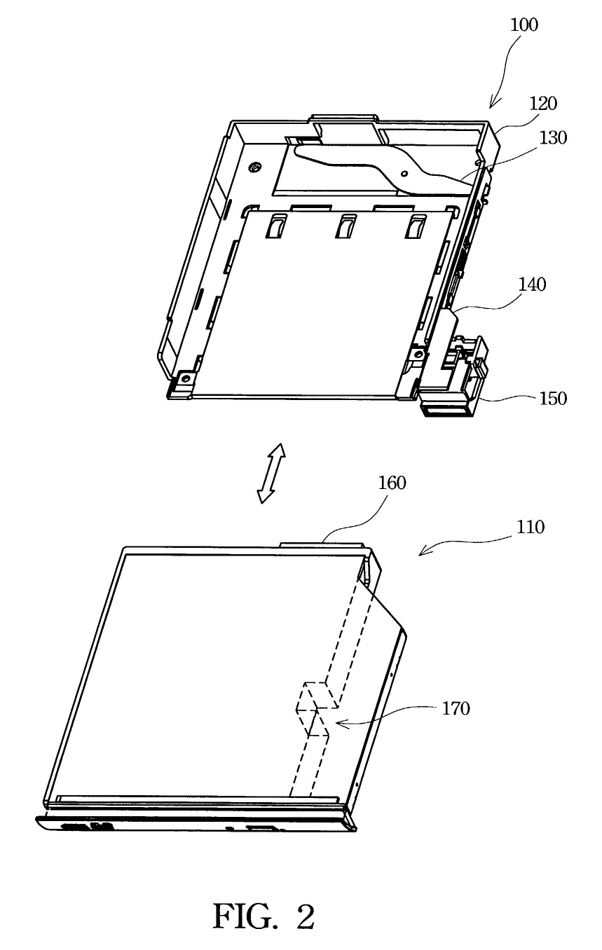

FIG. 2 is a preferred embodiment according to the present invention. The multipurpose changeable module according to the present invention comprises a module case 100 and a device module 110, such as a floppy disk drive, a second hard disk or a secondary battery. The module case 100 is installed in the motherboard of the notebook computer and keeps a predetermined gap between the motherboard and the module case 100 to avoid contact between the module case 100 and the electronic components on the motherboard. The module case 100 does not waste space on the motherboard and the motherboard need not be cut away to install the module case 100. The module case 100 includes a switch 150 to withdraw the device module 110. Therefore, when a user utilizes the multipurpose changeable module according to the present invention, the device module 110 is easily installed in the module case 100. The user pushes the device module 110 into the module case 100 until the connector 160 connects with the connector (not shown) on the motherboard. When the user needs withdraws the device module 110, the user only needs to push the switch 150. The switch 150 pushes a connecting rod 140, the connecting rod 140 slides on the casing 120 to move a push arm 130, and the push arm 130 pushes the device module 110 to disconnect the connector 160 from the connector on the motherboard and withdraw the device module 110. Accordingly, device module 110 in the multipurpose changeable module is easily changed, according to the present invention, to enhance the extension capacity of the notebook computer.

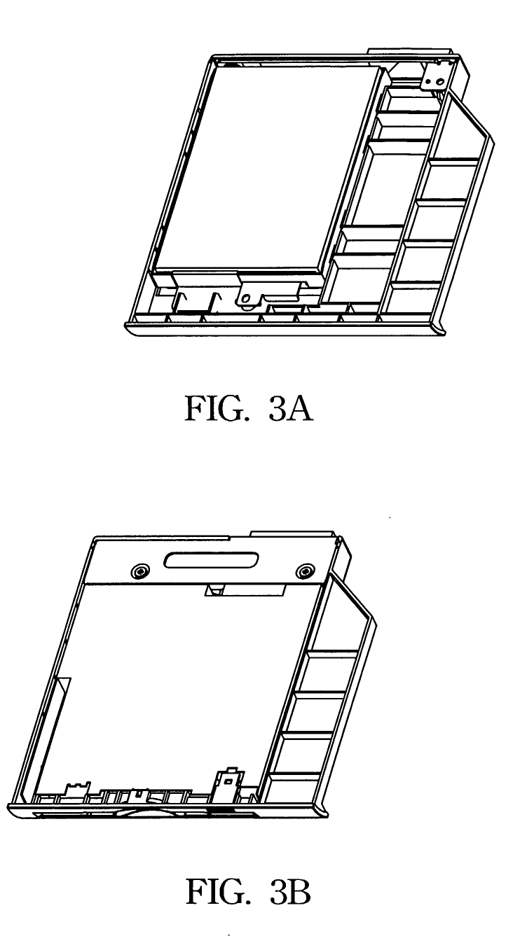

FIG. 3A shows a schematic view of a second hard disk, one changeable device module of FIG. 2. FIG. 3B shows a schematic view of a floppy disk drive, another changeable device module of FIG. 2. The changeable device module further comprises a secondary battery device module and the disk module such as a CD-ROM drive, a DVD-ROM drive or a CD-RW drive. The exemplary embodiment is not limited to the changeable device modules of the present invention; the present invention may utilize most of the peripheral devices of a notebook computer to form the changeable device modules.

The present invention allows the peripheral devices of the notebook computer to be changeable device modules. The notebook computer utilizes the changeable device modules of the present invention to make the notebook computer more powerful and enhance the mobility thereof. When the user wants to use any one of the changeable devices, the user only needs to push the selected changeable device into the module case until the connectors connect. The selected changeable device is immediately functional. Therefore, the user need not carry extension cables to connect peripheral devices. One embodiment of the changeable device according to the present invention is a secondary battery. The secondary battery provides an extended work time for the notebook computer. This provides a great benefit for a user working outside long time. The notebook computer with the secondary battery may change between the main and secondary battery without turning off the notebook computer. Therefore, the notebook computer can continue working.

The present invention ingeniously preserves a gap between the motherboard and the module case 100 to form a suitable space for the electronic components on the motherboard. The module case 100 according to the present invention utilizes attachment devices to attach the module case 100 to the casing of the notebook computer through the motherboard. The attachment devices, such as screws, go through the motherboard and attach the module case 100 directly to the casing, the motherboard need not be cut back for attachment of module case 10. Further, more electronic components can be mounted on the motherboard and more complicate electrical circuits can be designed. Hence, the space on the motherboard is increased and more flexible. Since the present invention has very little influence on motherboard design, the multipurpose changeable module according to the present invention may design in any part of the notebook computer, such as the four sides or the corners thereof.

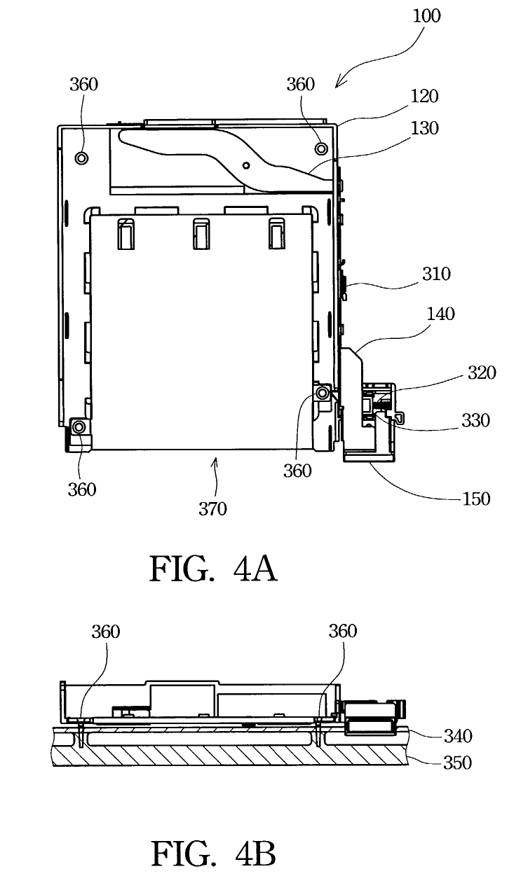

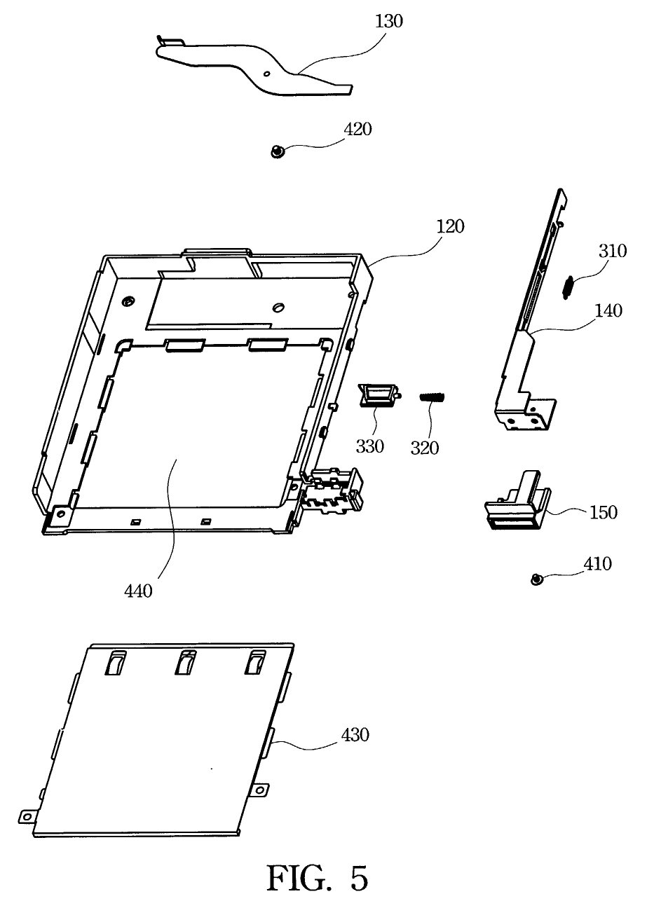

FIG. 4A is a top view of the preferred embodiment of FIG. 2. FIG. 4B is a front view of the preferred embodiment of FIG. 2 with the section of the motherboard and the lower casing. FIG. 5 is a detail drawing of the preferred embodiment of FIG. 2. Referring simultaneously to FIGS. 4A, 4B and 5, the present invention is described clearly.

The module case 100 according to the present invention is attached to the motherboard 340 and the lower casing 350 of the notebook computer by attachment devices 360, such as the screws. When the user wants to use one device module, the selected device module is pushed into the gate 370 of the module case 100. Then, the latch 330 touches the sidewall of the device module and moves back. Therefore, the device module is pushed into the module case 100. When the connector (connector 160 of FIG. 2) connects with the connector (not shown) inside the notebook computer, the latch 330 rebounds due to the spring force of the spring 320 and an opening 170. In this moment, the latch 330 locks the device module at the opening 170 (FIG. 2) and the device module is installed in the multipurpose changeable module according to the present invention.

When the user wants to remove a device module from the module case 100, the switch 150 is pushed. The switch 150 connects to the connecting rod 140 with an attachment device 410. First, the connecting rod 140 pushes the latch 330 back, and the latch 330 withdraws from the opening 170 and releases the device module. Then, the connecting rod 140 pushes the push arm 130 to rotate with a rotatable attachment device 420, such as a pin, to push the device module out. Therefore, the user can easily remove the device module from the module case. While the user releases the switch 150, the spring 310 pulls the connecting rod 140 back and the switch 150 also rebounds.

An isolation plate 430 installed in an opening 440 is formed by a metal plate and an insulating plate. The opening 440 and the isolation plate 430 make a bigger space between the module case 100 and the motherboard. Therefore, contact between the electronic components on the motherboard and the casing 120 of the module case 100 is avoided. The metal plate can conduct the electrostatic discharge current into the ground of the notebook computer. The notebook computer can thus reduce the electrostatic discharge damage for the present invention. The isolation plate 430 further separates the device module and the electronic component to reduce their influence. The switch according to the present invention further transfers an electrical signal to the application software of the notebook computer to enhance the safety of the device module and the notebook computer while the device module is withdrawn. The multipurpose changeable module can increase space on the motherboard by about 20-30%. When space of the motherboard is increased, the electrical circuits can be more complicated. The notebook computer function and performance can be enhanced. The notebook computer can use any device module as the user needs the same. The user can determine which device module is necessary for a trip. Therefore, the extension capability can be enhanced and the weight can be reduced. In particular, work time can be increased with a secondary battery module.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A multipurpose changeable module for a notebook computer, wherein a motherboard and a device module are located in the notebook computer, and the device module is changeable, the multipurpose changeable module comprising:
a module case for installing the device module, the module case being located inside the notebook computer and positioned above the motherboard
a switch for releasing the device module;
a connecting rod connected with the switch; and
a latch for locking the device module, the latch connecting with the connecting rod, wherein when the switch pushes the connecting rod, the latch releases the device module from the module case.

2. The multipurpose changeable module of claim 1, wherein the module case further comprises a push arm connecting with the connecting rod, and the connecting rod pushes the push arm and the push arm pushes out the device module after the latch withdraws from a recess of the device module.

3. The multipurpose changeable module of claim 1, wherein the device module includes a floppy disk drive, a hard disk, a compact disk drive, a rewritable compact disk drive, a digital video disk drive, and a battery.

4. The multipurpose changeable module of claim 1, wherein the switch further comprises an electrical signal sending to an application software of the notebook computer before the latch releases the device module.

5. The multipurpose changeable module of claim 1, wherein the module case further comprises an isolation plate to separate the device module and the electronic components.

6. A multipurpose changeable module for a notebook computer, a changeable device module and a motherboard located within the notebook computer, the multipurpose changeable module comprising:
a module case for installing the device module, the module case being located inside the notebook computer and above the motherboard of the notebook computer, wherein the module case is set with a predetermined distance from the motherboard to avoid the module case contact electronic components mounted on the motherboard.

7. The multipurpose changeable module of claim 6, wherein the module case further comprises:
a switch for releasing the device module;
a connecting rod connecting with the switch;
a latch for locking the device module, the latch connecting with the connecting rod, wherein when the switch pushes the connecting rod, the latch withdraws from a recess of the device module to release the device module from the module case; and
a push arm connected with the connecting rod, wherein the connecting rod pushes the push arm and the push arm pushes out the device module after the latch withdraws from the recess of the device module.

8. The multipurpose changeable module of claim 7, wherein the switch further comprises an electrical signal sent to an application software of the notebook computer before the latch releases the device module.

9. The multipurpose changeable module of claim 6, wherein the device module includes a floppy disk drive, a hard disk, a compact disk drive, a rewritable compact disk drive, a digital video disk drive and a battery.

10. The multipurpose changeable module of claim 6 wherein the module case further comprises an isolation plate to separate the device module and the electronic components.
